(19) United States
(12) Patent Application Publication
(10) Pub. No.: US 2026/0242546 A1
(43) Pub. Date: Aug. 20, 2026

(54) SILICONE - (METH)ACRYLATE - POLYETHER COPOLYMER AND METHODS FOR ITS PREPARATION AND USE AS A SURFACTANT FOR FOAM FORMULATIONS

(71) Applicants: Dow Global Technologies LLC, Midland, MI (US); Dow Silicones Corporation, Midland, MI (US); Rohm and Haas Company, Collegeville, PA (US)

(72) Inventors: Fang Zhang, Midland, MI (US); Matthew Carter, Bala Cynwyd, PA (US); Scott Boelter, Midland, MI (US); Rossella Riccio, Correggio (IT); Jodi Mecca, Midland, MI (US); Nanguo Liu, Midland, MI (US); Weijun Zhou, Sugarland, TX (US); Hai Wang, Royersford, PA (US)

(21) Appl. No.: 19/165,471

(22) PCT Filed: Mar. 22, 2024
(86) PCT No.: PCT/US2024/021020

§ 371 Date: Sep. 15, 2025

(30) Foreign Application Priority Data
May 23, 2023 (IT) 102023000010422

(51) Int. Cl. C08G 77/46; C08J 9/00

(52) U.S. Cl. CPC C08G 77/46; C08J 9/0042; C08J 2203/14; C08J 2203/182

(57) ABSTRACT

A silicone-(meth)acrylate-polyether copolymer includes a linear siloxane backbone with pendant (meth)acrylate-polyether moieties. The siloxane backbone is made up of a silicone moiety having a silicon bonded mercapto-alkyl linker (wherein the alkyl group in the linker is bonded to a silicon atom in the silicone moiety). The pendant (meth)acrylate-polyether moiety is covalently bonded to a sulfur atom in the mercapto-alkyl linker. The pendant (meth)acrylate-polyether moiety includes a (meth)acrylate-poly(alkylene glycol) unit. The silicone-(meth)acrylate-polyether copolymer is useful as a surfactant in polyurethane foam formulations and polyisocyanurate foam formulations.

### CROSS REFERENCE TO RELATED APPLICATIONS

This application claims the benefit of Italian Patent Application Serial No. 102023000010422 filed on 23 May 2023. Italian Patent Application Serial No. 102023000010422 is hereby incorporated by reference.

### FIELD

A silicone-(meth)acrylate-polyether copolymer and methods for its preparation and use are provided. More particularly, the silicone-(meth)acrylate-polyether copolymer comprises a linear siloxane backbone and a pendant (meth)acrylate-polyether moiety. The silicone-(meth)acrylate-polyether copolymer is useful as a surfactant in a foam formulation.

### INTRODUCTION

Good insulation performance is desired for rigid foams, in applications such as cold chain products, appliances, and construction. Foams with good insulation performance (low k-factor) can improve energy efficiency in these applications. Polyurethane and polyisocyanurate foam systems useful to prepare foams for these applications may contain silicone polyether (SPE) surfactants. SPE surfactants can improve emulsification and nucleation, prevent coalescence, stabilize cell membranes and sizes, increase ingredient compatibility, and decrease surface tension. The structure and performance of the SPE will impact the final performance of the foams, including the insulation performance and mechanical properties. However, SPEs may suffer from various drawbacks, such as containing impurities including aldehydes and ketones produced as side products in processes for manufacturing SPEs, resulting in foam formulations that are not free of formaldehyde or other small molecule volatile organic compounds.

There is an industry need for new surfactants useful in foam formulations with one or more of the following properties: the surfactant is desirably soluble in a polyol foam formulation and/or the surfactant desirably improves one or more of the following properties of a foam prepared from a formulation including the surfactant: increased stability, improved insulation performance (low k-factor), and/or improved fire resistance (low smoke density) to the foam.

### SUMMARY

A silicone-(meth)acrylate-polyether copolymer (Copolymer) comprises a linear backbone comprising a silicone moiety and a pendant (meth)acrylate-polyether moiety. The Copolymer may be prepared via a method comprising a free radical polymerization reaction of a mercapto-functional polydiorganosiloxane and a (meth)acrylate-poly(alkylene glycol). The Copolymer may be used as a surfactant in a foam formulation.

### DETAILED DESCRIPTION

As introduced above, the silicone-(meth)acrylate-polyether copolymer (Copolymer) comprises the linear backbone (comprising the silicone moiety) and the pendant (meth)acrylate-polyether moiety. The (meth)acrylate group in the pendant (meth)acrylate-polyether moiety is covalently bonded to a sulfur atom in a mercapto-alkyl linker, where the alkyl group in the linker is covalently bonded to a silicon atom in the silicone moiety. The pendant (meth)acrylate-polyether moiety comprises a (meth)acrylate-poly(alkylene glycol) unit and may optionally further comprise an additional (meth)acrylate monomer unit. As described in detail below, in the method for making the Copolymer, the silicone moiety is derived from A) a mercapto-functional polydiorganosiloxane. The (meth)acrylate-poly(alkylene glycol) unit is derived from B) a (meth)acrylate-poly(alkylene glycol), and the additional (meth)acrylate monomer unit, when present, is derived from C) a (meth)acrylate monomer.

The Copolymer may comprise at least 20 wt %, alternatively at least 29 wt %, alternatively at least 29.9 wt %, alternatively at least 30 wt %, alternatively at least 35 wt %, alternatively at least 39.9 wt % of the silicone moiety, based on combined weights of reactants used to prepare the Copolymer; while at the same time the Copolymer may comprise <60 wt %, alternatively up to 58.5 wt %, alternatively up to 58 wt %, alternatively up to 50 wt %, alternatively at up to 42.9 wt %, alternatively up to 42 wt % of the silicone moiety on the same basis. Alternatively, the Copolymer may comprise 20 wt % to <60 wt % of the silicone moiety, alternatively 20 wt % to 58.5 wt %, and alternatively 42.9 wt % to 58 wt % of the silicone moiety, on the same basis.

The Copolymer further comprises the (meth)acrylate-polyether moiety in an amount >40 wt % to 80 wt %, based on combined weights of the reactants used to prepare the Copolymer. Alternatively, the (meth)acrylate-polyether moiety may be present in an amount of at least 41 wt %, alternatively at least 42 wt %, alternatively, at least 45 wt %, alternatively at least 50 wt %, on the same basis; while at the same time the (meth)acrylate-polyether moiety may comprise up to 80 wt %, alternatively up to 75 wt %, alternatively up to 71 wt %, alternatively up to 65 wt %, alternatively up to 61 wt %, alternatively up to 58 wt %, alternatively up to 50 wt % of the (meth)acrylate-polyether moiety on the same basis. Alternatively, the Copolymer may comprise 41 wt % to 80 wt %, alternatively 42 wt % to 58 wt %, of the (meth)acrylate-polyether moiety, on the same basis.

The pendant (meth)acrylate-polyether moiety comprises a (meth)acrylate-poly(alkylene glycol) unit and may optionally further comprise the additional (meth)acrylate monomer unit. The Copolymer may comprise at least 28 wt %, alternatively at least 33 wt %, alternatively at least 35 wt %, alternatively at least 39 wt %, alternatively at least 40 wt % of the (meth)acrylate-poly(alkylene glycol) unit based on combined weights of the reactants used to make the Copolymer; while at the same time, the Copolymer may comprise up to 80 wt %, alternatively up to 65 wt %, alternatively up to 64 wt %, alternatively up to 60 wt %, alternatively up to 56 wt %, alternatively up to 52 wt %, and alternatively up to 40 wt % of the (meth)acrylate-poly(alkylene glycol) unit on the same basis. Alternatively, the Copolymer may comprise 28.8 wt % to 64 wt %, alternatively 33.6 wt % to 40 wt % of the (meth)acrylate-poly(alkylene glycol) unit on the same basis.

The Copolymer may optionally further comprise up to 30 wt %, alternatively up to 23 wt % of the additional (meth)acrylate monomer unit, based on combined weights of reactants used to the Copolymer. Alternatively, the Copolymer may comprise at least 1 wt %, alternatively at least 2 wt %, alternatively at least 4 wt %, alternatively at least 8 wt %, and alternatively at least 10 wt % of the additional (meth)acrylate monomer unit on the same basis; while at the same time the Copolymer may comprise up to 23 wt %, alternatively up to 20 wt %, alternatively up to 16 wt %, alternatively up to 15 wt %, alternatively up to 14 wt %, alternatively up to 13 wt % of the (meth)acrylate monomer unit on the same basis. Alternatively, the Copolymer may comprise 8 wt % to 23 wt %, alternatively 8 wt % to 12 wt % of the (meth)acrylate monomer unit on the same basis.

The Copolymer may comprise unit formula (I): (R¹₂SiO_{2/2})ₓ(R¹R²SiO_{2/2})_{y}(R¹₃SiO_{1/2})_{z}, where subscripts x, y, and z each represent average numbers of each unit in the unit formula, and subscripts x, y, and z have values such that z=2, x=10 to 40, and y=1 to 10; each R¹ is an independently selected alkyl group of 1 to 10 carbon atoms; each R² is an independently selected group of formula: -D¹-S—R¹⁰, where each D¹ is an independently selected alkane-diyl group of 1 to 16 carbon atoms, and R¹⁰ comprises formula (II):

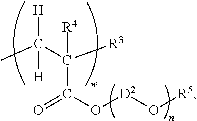

where each R³ can be an endblocker of a poly(meth)acrylate chain in the pendant (meth)acrylate-polyether moiety each R⁴ is independently selected from H or methyl, each D² is independently selected alkane-diyl group of 2 to 4 carbon atoms, each subscript n is independently 1 to 25, each R⁵ is independently selected from H and an alkyl group of 1 to 4 carbon atoms, each subscript w is independently >0 to 20, alternatively 1 to 20, and alternatively 1 to 15, and with the provisos that in at least one instance of R¹⁰, per molecule, subscript n is 5 to 25.

In unit formula (I) above, each R¹ is an independently selected alkyl group of 1 to 10 carbon atoms, such as methyl, ethyl, propyl (including n-propyl and isopropyl), butyl (including n-butyl, t-butyl, iso-butyl, and sec-butyl), pentyl, hexyl, heptyl, octyl, nonyl and decyl (each including linear and branched alkyl groups, i.e., of 5 to 10 carbon atoms). Alternatively, each R¹ may be methyl.

In unit formula (I) above, each D¹ is an independently selected alkane-diyl group of 1 to 16, alternatively 2 to 16, and alternatively 2 to 10, carbon atoms. The alkane-diyl group may be linear or branched and has empirical formula —CᵣH₂ᵣ, where subscript r is 1 to 16, alternatively 2 to 16, alternatively 2 to 10, alternatively 2 to 6, and alternatively 2 to 4. Examples of suitable alkane-diyl groups for D¹ include —C₂H₄—, —C₃H₆—, —C₄H₈—. Alternatively, D¹ may be —C₃H₆— (e.g., propane-diyl).

In unit formula (I), subscript z represents the number of monofunctional (terminal) units per molecule, and subscript z=2. Subscripts x and y represent average numbers of each difunctional siloxane unit per molecule. Subscript x may be 10 to 40. Alternatively, subscript x may be at least 15, alternatively at least 20, alternatively at least 24; while at the same time, subscript x may be up to 39, alternatively up to 38, alternatively up to 37, and alternatively up to 36. Subscript y may be 1 to 10. Alternatively, subscript y may be at least 2, alternatively at least 2.2, alternatively at least 2.4; while at the same time, subscript y may be up to 8, alternatively up to 6. The Copolymer may have any distribution of the pendant (meth)acrylate-polyether moiety, R², such as block or random. Alternatively, the Copolymer may have a random distribution of pendant (meth)acrylate-polyether moieties, R².

In formula (II), each R³ is an endblocker of the poly(meth)acrylate chain in the pendant (meth)acrylate-polyether moiety. R³ may be H. Alternatively, R³ may be another structure resulting from termination of the free radical polymerization to make the Copolymer, as described below.

In formula (II) above, each D² is an independently selected alkane-diyl group of 2 to 4 carbon atoms. The alkane-diyl group may be linear or branched and has empirical formula —CₛH₂ₛ, where subscript s is 2 to 4, alternatively 2 to 3, and alternatively 2. Examples of suitable alkane-diyl groups for D¹ include —C₂H₄—, —C₃H₆—, —C₄H₈—. Alternatively, D¹ may be —C₂H₄— or —C₃H₆—.

In formula (II), each R⁵ is hydrogen or an alkyl group of 1 to 4 carbon atoms. For example, the alkyl group for R⁵ may be methyl, ethyl, propyl (including n-propyl and isopropyl), butyl (including n-butyl, t-butyl, iso-butyl, and sec-butyl). Alternatively, each R⁵ may be independently selected from the group consisting of H and methyl. Alternatively, each R⁵ may be an alkyl group; alternatively methyl.

In formula (II), subscript w represents the average number of (meth)acrylate-poly(alkylene glycol) units (and, when present, the average number of additional (meth)acrylate monomer units) per group R¹⁰. Each subscript w independently has a value>0, alternatively, each subscript w has a value of at least 1, alternatively 1 to 20, alternatively 1 to 15, alternatively 1 to 10, alternatively 2 to 15.

In formula (II), subscript n represents the average number of alkylene glycol units. In the (meth)acrylate-poly(alkylene glycol) unit, subscript n is 5 to 25. In the additional (meth)acrylate monomer unit, subscript n=1. In at least one instance of R¹⁰, per molecule, subscript n is 5 to 25, alternatively 6 to 20.

Alternatively, R¹⁰ may comprise general formula (III):

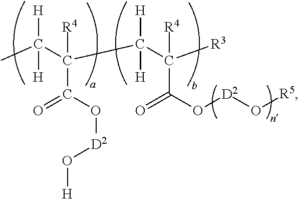

where R⁴, R³, D², and R⁵ are as described above for formula (II), each subscript n′ is independently 5 to 25, alternatively 6 to 20, subscript a represents an average value of additional (meth)acrylate monomer units per group R¹⁰, subscript b represents an average value of (meth)acrylate-poly(alkylene glycol) units per group R¹⁰, and a quantity (a+b)=w. Alternatively, subscript a may be 0 to 10, and subscript b may be >0 to 10, alternatively 1 to 10, and alternatively 1 to 5. One skilled in the art would recognize that the additional (meth)acrylate monomer units with subscript a and (meth)acrylate-poly(alkylene glycol) units with subscript b may be in any order and when a>1 and b>1, these units are not necessarily in blocks as shown in general formula (III) above, e.g., the units may have a random distribution.

### Method for Making the Copolymer

The Copolymer described herein may be prepared by a method comprising:
1) combining, under conditions to effect free radical polymerization reaction, starting materials comprising
   A) a mercapto-functional polydiorganosiloxane comprising unit formula (IV): (R¹₂SiO_{2/2})ₓ (R¹R⁹SiO_{2/2})_{y} (R¹₃SiO_{1/2})_{z}, where each R⁹ is an independently selected mercaptoalkyl group of formula -D¹-SH, and subscripts x, y, and z and R¹ and D¹ are as described and exemplified above for unit formula (I);
   B) a (meth)acrylate-poly(alkylene glycol) of formula (V):

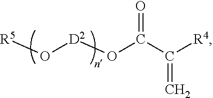

where R⁵, D², and R⁴ are each as described and exemplified above for formula (II), and subscript n′ is as described above for formula (III); optionally C) a (meth)acrylate monomer of formula (VI):

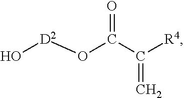

where D² and R⁴ are each as described and exemplified above for formula (II);
D) a free radical initiator; and
optionally E) a solvent,
thereby producing a reaction product comprising the copolymer; and
optionally 2) purifying the reaction product, thereby recovering the copolymer.

Step 1) of the method described herein may be performed by any convenient means. The starting materials may be combined in any order in any suitable reactor. For example, starting materials comprising A) the mercapto-functional polydiorganosiloxane and B) the (meth)acrylate-poly(alkylene glycol) (and when used C) the (meth)acrylate monomer and E) the solvent) may be combined in a reactor, e.g., with mixing means such as an impeller or baffles. Starting material D), the free radical initiator, may be added to the reactor. One or more of starting materials A), B), C) and D) may optionally be dissolved in E) the solvent before mixing with the other starting materials. The starting materials may be combined under an inert atmosphere, such as nitrogen. Step 1) may further comprise mixing and optionally heating the starting materials. The temperature may depend on various factors such as the selection of solvent, however, step 1) may be performed at a temperature of up to 150° C., alternatively RT to <100° C., and alternatively RT to 65° C. Reaction time depends on various factors such as the type and amount of free radical initiator selected for starting material D), however, the reaction time may be 30 mins to 24 hours, alternatively 30 mins to 8 hours.

Step 1) produces a reaction product comprising the Copolymer. The reaction product may further comprise one or more additional components, such as an unreacted starting material, D) the free radical initiator, E) the solvent, if used, and a side product, such as a poly(meth)acrylate polymer, e.g., formed by polymerizing the (meth)acrylate groups of a portion of starting material B) and/or copolymerizing the (meth)acrylate groups of portions of starting materials B) and/or C), when starting material C) is present.

The method may optionally further comprise step 2): purifying the reaction product, thereby recovering the Copolymer. Purifying may be performed by any convenient means, such as precipitation, filtration, stripping and/or distillation with heating and optionally under reduced pressure. The product of step 2) is the Copolymer having minimized or eliminated content of the one or more additional components of the reaction product, described above. The starting materials used in the method are described in detail, below.

### A) Mercapto-Functional Polydiorganosiloxane

Starting material A) is a reactant used in the method is the mercapto-functional polydiorganosiloxane. The mercapto-functional polydiorganosiloxane comprises unit formula (IV): (R¹₂SiO_{2/2})ₓ(R¹R¹⁰SiO_{2/2})_{y}(R¹₃SiO_{1/2})_{z}, where subscripts x, y, and z each represent average numbers of each unit in the unit formula, and subscripts x, y, and z have average values as defined above for the Copolymer, each R¹ is an independently selected alkyl group of 1 to 10 carbon atoms; and each R¹⁰ is an independently selected mercapto-alkyl group of formula -D¹-SH, where each D¹ is an independently selected alkane-diyl group of 1 to 16 carbon atoms, wherein R¹ and D¹ are as described and exemplified above for the Copolymer.

The mercapto-functional polydiorganosiloxane may have any distribution of the pendant mercapto-alkyl groups R¹⁰, such as block or random. Alternatively, the copolymer may have a random distribution of pendant mercapto-alkyl groups, R¹⁰.

Examples of mercapto-functional polydiorganosiloxanes suitable for use herein include bis-trimethylsiloxy-terminated poly(dimethyl/methyl,mercaptopropyl) siloxanes. Methods for preparing mercapto-functional polydiorganosiloxanes are known as disclosed, for example, in U.S. Pat. No. 5,202,190 and the references cited therein. Pendant mercapto-functional polydiorganosiloxanes are commercially available and are exemplified by poly(dimethyl/methyl,mercaptoalkyl) siloxanes are available from Genesee Polymers Corporation of Burton, Michigan, USA, for example, GP-367 from Genesee Polymers Corporation may be used in the method herein.

### B) (Meth)Acrylate-Poly(Alkylene Glycol)

Starting material B) is a reactant used in the method for making the Copolymer is a (meth)acrylate-poly(alkylene glycol) of formula (V):

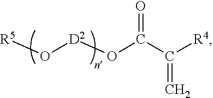

where each R⁵ is independently selected from H and an alkyl group of 1 to 4 carbon atoms, each D² is independently selected alkane-diyl group of 2 to 4 carbon atoms, each R⁴ is independently selected from H or methyl, each as described and exemplified above, and subscript n′ is 5 to 25 (alternatively 6 to 20) as described above. For example, the (meth)acrylate-poly(alkylene glycol) may comprise poly(ethylene glycol) methyl ether (meth)acrylate with average molecular weight (Mn) of 300 to 480 g/mole. (Meth)acrylate-poly(alkylene glycols) are known in the art and are commercially available. For example, poly(ethylene glycol) methyl ether acrylate and poly(ethylene glycol) methyl ether methacrylate are commercially available from various sources such as Millipore Sigma of St. Louis, Missouri, USA (Sigma) and TCI America of Portland, Oregon, USA.

### C) Additional (Meth)Acrylate Monomer.

Starting material C) is a (meth)acrylate monomer, which is an optional additional reactant that may be used to make the Copolymer herein. Starting material C) has formula (VI):

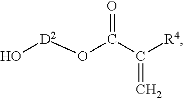

where each D² is independently selected alkane-diyl group of 2 to 4 carbon atoms, and each R⁴ is independently selected from H or methyl, each as described and exemplified above. Examples of suitable (meth)acrylate monomers include hydroxybutyl (meth)acrylate, hydroxyethyl (meth)acrylate, and hydroxypropyl (meth)acrylate, all of which are known in the art and are commercially available, e.g., from BASF SE or Sigma. Alternatively, C) the additional (meth)acrylate monomer may comprise hydroxyethylmethacrylate.

Starting materials A) and B), and C), when present described above are the reactants used in amounts to provide the Copolymer with the amounts of silicone moieties and pendant (meth)acrylate polyether moieties and the units thereof, described above.

### D) Free Radical Initiator

Starting material D) used in the method is a free radical initiator. Free radical initiators are known in the art and are exemplified by peroxides, azo compounds, peracids, and peresters. The peroxide may be an organic peroxide or a hydroperoxide, such as benzoyl peroxide; 4-monochlorobenzoyl peroxide; t-butylperoctoate; t-butyl peroxybenzoate, tert-butylperoxybenzoate, tert-butyl cumyl peroxide, tert-butyloxide 2,5-dimethyl-2,5-di-tert-butylperoxyhexane; 2,4-dichlorobenzoyl peroxide; di-tertbutylperoxy-diisopropyl benzene; 1,1-bis(tert-butylperoxy)-3,3,5-trimethylcyclohexane; 2,5-di-tert-butylperoxyhexane-3,2,5-dimethyl-2,5-bis(tert-butylperoxy) hexane; cumyl-tert-butyl peroxide; dicumyl peroxide; di-t-butyl peroxide; t-butyl hydroperoxide; cumene hydroperoxide; di-t-amyl peroxide; and combinations of two or more thereof. Additionally, di-peroxide radical initiators may be used alone or in combination with other radical initiators. Such di-peroxide radical initiators include, but are not limited to, 1,4-bis-(t-butyl peroxycarbo)cyclohexane; 1,2-di(t-butyl peroxy)cyclohexane; and 2,5-di(t-butyl peroxy)-3-hexyne. Suitable peroxide compounds are known in the art and are commercially available from various sources, such as Sigma.

The azo compound may be an aliphatic azo compound such as 1-t-amylazo-1-cyanocyclohexane; azo-bis-isobutyronitrile; and 1-t-butylazo-cyanocyclohexane; 2,2′-azo-bis-(2-methyl) butyronitrile; 2,2′-azobis(2-methylpropionitrile); 2,2′-azobis(2-methylpropionamidine) dihydrochloride; 2,2′-azobis(cyanovaleric acid); or a combination of two or more thereof. Azo compounds are known in the art and are commercially available, e.g., under the tradename VAZO™ WSP from The Chemours Company of Wilmington, Delaware, USA. Furthermore, peroxides and azo compounds are disclosed at paragraphs to of U.S. Patent Application Publication 2014/0287642. Initiators are also disclosed in U.S. Pat. No. 5,202,190. Alternatively, the initiator used in the method described herein may be an azo compound, such as 2,2′-azobis(2-methylpropionitrile), which is commercially available from Sigma. The amount of free radical initiator depends on various factors including the type of initiator and reaction conditions, such as temperature, selected. Alternatively, the amount of initiator may be 0.1 wt % to 5 wt %, alternatively 0.4 wt % to 2 wt %, based on combined weights of starting materials A), B), and C).

### E) Solvent

Starting material E) is a solvent that may optionally be used in the method described herein to dissolve or disperse one or more of the starting materials before and/or during step 1). For example, D) the free radical initiator may be dissolved in the solvent before or during mixing with the other starting materials, described herein. Suitable solvents may be organic solvents including aromatic hydrocarbon solvents such as toluene and xylene; aliphatic hydrocarbon solvents such as hexane, heptane, octane, isooctane, decane, cyclohexane, methylcyclohexane, and isoparaffin; hydrocarbon solvents such as industrial gasoline, petroleum benzene, and solvent naphtha; ketone solvents such as acetone, methyl ethyl ketone, 2-pentanone, 3-pentanone, 2-hexanone, 2-heptanone, 4-heptanone, methyl isobutyl ketone, diisobutylketone, acetonylacetone, and cyclohexanone; ester solvents such as ethyl acetate, propyl acetate, isopropyl acetate, butyl acetate, and isobutyl acetate; ether solvents such as diethyl ether, dipropyl ether, diisopropyl ether, dibutyl ether, 1,2-dimethoxyethane, and 1,4-dioxane. Alternatively, the solvent may comprise a siloxane solvent such as hexamethyldisiloxane, octamethyltrisiloxane, octamethylcyclotetrasiloxane, decamethylcyclopentasiloxane, tris(trimethylsiloxy) methylsilane, and tetrakis(trimethylsiloxy) silane; and mixtures thereof, which are commercially available from various sources such as Gelest, Inc. of Morrisville, Pennsylvania, USA and from Dow. The amount of solvent is not critical, and may be, for example 1 wt % to 99 wt % based on combined weights of starting materials A), B), C), D) and E).

### Method of Use

The Copolymer described above is useful as a surfactant in a foam formulation, such as a foam formulation used to prepare a polyurethane and/or polyisocyanurate foam. The Copolymer may be used in addition to, or instead of, an SPE surfactant in the foam formulation, such as the foam formulation disclosed in U.S. Pat. No. 4,751,251 to Thornsberry. For example, the foam formulation may comprise i) an isocyanate where suitable isocyanates may include any of the organic isocyanates known in the art that contain more than one isocyanate (NCO) group for preparing polyurethanes, such as aliphatic, cycloaliphatic, araliphatic and aromatic isocyanates; ii) a polyol (e.g., a polyether polyol or a polyester polyol and a mixture thereof); optionally iii) a flame retardant additive such as triethyl phosphate; iv) a blowing agent such as water, formic acid, cyclopentane, isopentane, various hydrofluoroolefins (HFOs) such as trans-1,3,3,3-tetrafluoroprop-1-ene, 1,3,3,3-tetrafluoropropene, or a combination thereof; and optionally v) a catalyst for promoting polyurethane or polyisocyanurate reactions (e.g., a blowing catalyst, a gelation catalyst and a trimerization catalyst, such as potassium acetate, or N,N,N′,N″,N″-pentamethyldiethylenetriamine); and vi) a surfactant, where the surfactant comprises the Copolymer described above. The foam formulation may optionally further comprise a co-surfactant, which has a chemical structure different from the Copolymer described above. The foam formulation may have two parts, for example i) the isocyanate may be stored in a first part (A-side) stored separately from a second part (B-side) comprising ii) the polyol, iv) the blowing agent, and vi) the surfactant. The second part may optionally further comprise an additive selected from the group consisting of iii) the flame retardant, v) the catalyst, and the co-surfactant. The parts may be combined, e.g., by mixing the first part and the second part shortly before use, e.g., dispensing into a mold to form a foam. Examples of isocyanates, polyols, flame retardants, blowing agents, and catalysts are as described in U.S. Pat. No. 4,751,251 and below in the examples.

### EXAMPLES

These examples are provided to illustrate the invention to one skilled in the art and are not to be construed as limiting the scope of the invention set forth in the claims. Starting materials used in the examples are summarized below in Tables 1, 2, and 4.

TABLE 1
Starting Materials for Synthesis of Mercapto-Functional Siloxanes

| Type | Name | Chemical Description | Formula | Source |
|---|---|---|---|---|
| Reactant | HMDS | hexamethyldisiloxane | 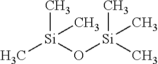 | DOW |
| Reactant | MPMDMS | 3-mercaptopropylmethyl | See below | Alfa Aesar |
| | | dimethoxysilane | | |
| Reactant | DMS-S12 | Silanol-terminated | See below | Gelest |
| | | PDMS with DP = 4 | | |
| Catalyst | FC-24 | Trifluoromethane sulfonic | CF₃SO₃H | Sigma |
| | | acid | | |
| Neutralizer | CaCO3 | Calcium carbonate | CaCO₃ | Sigma |

In Table 1, 3-mercaptopropylmethyldimethoxysilane had formula:

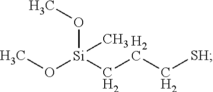

and silanol-terminated PDMS had formula

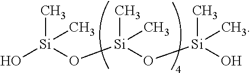

In this Synthesis Example 1, a mercapto-functional siloxane was prepared as follows:

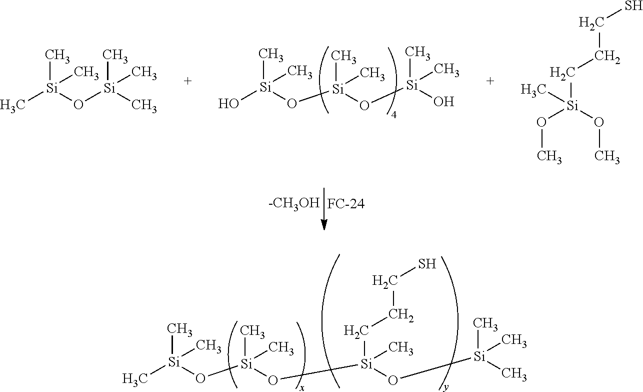

367.0 g of silanol-terminated PDMS, 40.1 g of hexamethyldisiloxane (HMDS), 73.0 g of 3-mercaptopropylmethyldimethoxysilane (MPMDMS), 16.6 g of deionized (DI) water, and 95.8 g of heptane were charged into a 1000 mL 4-neck flask equipped with a mechanical stirrer, a thermocouple, and a Dean-Stark trap equipped with a condenser and N₂ outlet to a bubbler. The flask was purged with N₂ for 3 minutes (at a flow rate of 2 L per min), after which time a heating block was used to heat the reaction mixture. When the reaction mixture reached 60° C., 0.6 mL of trifluoromethane sulfonic acid was added. A liquid began to collect in the Dean-Stark trap when the reaction mixture reached approximately 78° C. After 45 minutes at ~78° C. 12.0 g of liquid had been collected. At this time, 20.0 g of DI water was added to the reactor. The temperature of the reaction mixture rose as additional liquid was observed to collect in the Dean-Stark trap. After approximately 4 hours, the pot temperature had risen to approximately 122° C., and no additional liquid was observed collecting in the Dean-Stark trap. The heating block was removed and 24.0 g of CaCO₃ was added to the reactor at the point when the reaction mixture reached 70° C. The mixture was then stirred overnight at RT. After cooling to room temperature, the reaction mixture was filtered through a 0.45 μm nylon membrane. Volatile species were evacuated under reduced pressure using a rotary evaporator with a heating bath set to 100° C. and a pressure of ~1 torr for 1.5 hour. 376.4 g of clear liquid was obtained. The resulting mercapto-functional PDMS was used in copolymer synthesis, described below.

TABLE 2
Starting Materials for Copolymer Synthesis.

| Type | Name | Chemical Description | Source |
|---|---|---|---|
| Reactant C) | HEMA | Hydroxyethyl methacrylate | Sigma |
| Reactant B) | PEGA-480 | Poly(ethylene glycol) | Sigma |
| | | methyl ether acrylate, | |
| | | average Mn = 480 Da | |
| Reactant B) | PEGMA-300 | Poly(ethylene glycol) | Sigma |
| | | methyl ether methacrylate, | |
| | | average Mn = 300 Da | |
| Reactant A) | Mercapto-functional | x = 36 | Genesee Polymer Corp. |
| | PDMS GP-367 | y = 6 | |
| | | Viscosity at 25 C., 150 cP | |
| | | wt % SH = 5.4% | |
| Macro chain | Mercapto-functional | x = 83 | Genesee Polymer Corp. |
| transfer | PDMS GP-71-SS | y = 2 | |
| agent | | Viscosity at 25 C., 100 cP | |
| | | wt % SH =1.0% | |
| Reactant A) | Mercapto-functional | x = 24 | Dow, Experimental |
| | PDMS (SE1) | y = 2.4 | material prepared |
| | | Mn = 2.3 kDa, | according to Synthesis |
| | | wt % SH = 3.5% | Example 1 |
| Solvent | EtOAc | Ethyl acetate | Sigma |
| Initiator | AIBN | 2,2′-Azobis(2- | Sigma |
| | | methylpropionitrile) | |

In Table 2, above, HEMA has formula

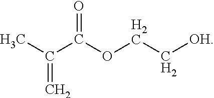

PEGA-480 has formula

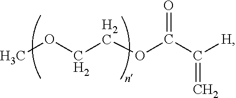

where n′ is sufficient to provide PEGA-480 with Mn=480 Da. PEGMA-300 has formula

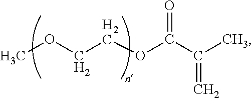

where n′ is sufficient to provide PEGMA-300 with Mn=300 Da. Each Mercapto-functional PDMS in Table 2 has the general formula:

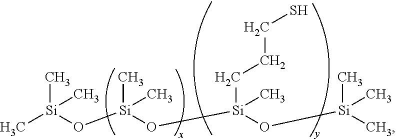

where subscripts x and y are as shown above in Table 2, and where the difunctional units with subscripts x and y are not necessarily in blocks, but may be randomly or semi-randomly distributed in the polydiorganosiloxane.

In this Synthesis Example 2, Copolymers were prepared. The following is a representative example for the synthesis of sample “4-A”. Mercapto-functional PDMS GP-367 (15.0 g), PEG-acrylate (12.0 g), HEMA (3.0 g), and EtOAc (75.0 g) were added to a glass reactor outfitted with a thermocouple, N₂ inlet, condenser, and stainless steel impeller. The reactor contents were stirred at 150 RPM. The reactor contents were sparged with N₂ for 15 mins at room temperature while stirring at 150 RPM. AIBN (0.80 g) was added to the reactor. The reactor contents were then placed under a N₂ blanket, and heated from 25° C. to 65° C. over 30 mins, while stirring at 250 RPM. The reactor contents were then stirred for 6 hrs at 65° C. After cooling to RT, the reactor contents were evacuated under reduced pressure on a rotary evaporator, and then transferred to a pear-shaped flask equipped with a stir bar and placed in a water bath at 50° C. The contents of the flask were stirred vigorously, and placed under high vacuum (~50 milliTorr, 6.67 Pa) for ~4 hr. The contents of the flask were then left overnight under high vacuum at RT and collected for use. Additional samples were made using modifications to this procedure, by varying the relative composition of starting materials, as listed in Table 3.

TABLE 3
Silicone, polyether, (meth)acrylate copolymers prepared
according to the procedure of Synthesis Example 2.

| | | Mercapto | | | | | | | |
|---|---|---|---|---|---|---|---|---|---|
| Sample | Mercapto | PDMS | | PEG(M)A | HEMA | EtOAc | AIBN | % | % |
| ID | PDMS | (g) | PEG(M)A | (g) | (g) | (g) | (g) | Silicone | PEG(M)A |
| 1--A | GP-71- | 25.0 | PEGMA-300 | 2.8 | 0 | 65 | 1.24 | 89.9 | 10.1 |
| | SS | | | | | | | | |
| 1--B | GP-71- | 25.0 | PEGMA-300 | 6.3 | 0 | 75 | 1.24 | 79.9 | 20.1 |
| | SS | | | | | | | | |
| 1--C | GP-71- | 25.0 | PEGMA-300 | 10.7 | 0 | 85 | 1.24 | 70.0 | 30.0 |
| | SS | | | | | | | | |
| 1--D | GP-71- | 25.0 | PEGMA-300 | 16.7 | 0 | 100 | 1.24 | 60.0 | 40.0 |
| | SS | | | | | | | | |
| 2--A | GP-71- | 25.0 | PEGA-480 | 2.8 | 0 | 65 | 1.24 | 89.9 | 10.1 |
| | SS | | | | | | | | |
| 2--B | GP-71- | 25.0 | PEGA-480 | 6.3 | 0 | 75 | 1.24 | 79.9 | 20.1 |
| | SS | | | | | | | | |
| 2--C | GP-71- | 25.0 | PEGA-480 | 10.7 | 0 | 85 | 1.24 | 70.0 | 30.0 |
| | SS | | | | | | | | |
| 2--D | GP-71- | 25.0 | PEGA-480 | 16.7 | 0 | 100 | 1.24 | 60.0 | 40.0 |
| | SS | | | | | | | | |
| 3--A | GP-367 | 15.0 | PEGA-480 | 12.0 | 3.0 | 75 | 0.40 | 50.0 | 40.0 |
| 3--B | GP-367 | 12.5 | PEGA-480 | 15.0 | 3.8 | 80 | 0.34 | 39.9 | 47.9 |
| 3--C | GP-367 | 10.0 | PEGA-480 | 18.7 | 4.7 | 85 | 0.27 | 29.9 | 56.0 |
| 3--D | GP-367 | 7.5 | PEGA-480 | 24.0 | 6.0 | 90 | 0.20 | 20.0 | 64.0 |
| 4--A | GP-367 | 15.0 | PEGA-480 | 12.0 | 8.0 | 75 | 0.80 | 42.9 | 34.3 |
| 4--B | GP-367 | 10.0 | PEGA-480 | 15.0 | 3.8 | 80 | 0.67 | 34.7 | 52.1 |
| 4--C | GP-367 | 10.0 | PEGA-480 | 18.7 | 4.7 | 85 | 0.54 | 29.9 | 56.0 |
| 4--D | GP-367 | 7.5 | PEGA-480 | 24.0 | 6.0 | 90 | 0.40 | 20.0 | 64.0 |
| 5--A | GP-367 | 15.0 | PEGA-480 | 12.0 | 3.0 | 75 | 0.20 | 50.0 | 40.0 |
| 5--B | GP-367 | 12.5 | PEGA-480 | 15.0 | 3.8 | 80 | 0.17 | 39.9 | 47.9 |
| 5--C | GP-367 | 10.0 | PEGA-480 | 18.7 | 4.7 | 85 | 0.13 | 29.9 | 56.0 |
| 5--D | GP-367 | 7.5 | PEGA-480 | 24.0 | 6.0 | 90 | 0.10 | 20.0 | 64.0 |
| 6--A | SE1 | 25.0 | PEGA-480 | 14.5 | 3.6 | 100 | 0.22 | 58.0 | 33.6 |
| 6--B | SE1 | 25.0 | PEGA-480 | 17.5 | 7.5 | 115 | 0.22 | 50.0 | 35.0 |
| 6--C | SE1 | 25.0 | PEGA-480 | 20.0 | 5.0 | 115 | 0.22 | 50.0 | 40.0 |
| 6--D | SE1 | 25.0 | PEGA-480 | 12.3 | 5.4 | 100 | 0.22 | 58.5 | 28.8 |
| 7--A | SE1 | 25.0 | PEGA-480 | 16.3 | 1.8 | 100 | 0.22 | 58.0 | 37.8 |
| 7--B | SE1 | 25.0 | PEGA-480 | 17.2 | 0.9 | 100 | 0.22 | 58.0 | 39.9 |
| 7--C | SE1 | 25.0 | PEGA-480 | 17.7 | 0.5 | 100 | 0.22 | 57.9 | 41.0 |
| 7--D | SE1 | 25.0 | PEGA-480 | 18.1 | 0 | 100 | 0.22 | 58.0 | 42.0 |

In Table 3, above, % Silicone refers to the weight % of Mercapto-functional PDMS used based on combined weights of Mercapto-functional PDMS, PEG(M)A, and HEMA used to prepare the copolymer. % PEG(M)A refers to the weight % of polyethylene glycol (meth)acrylate based on combined weights of Mercapto-functional PDMS, PEG(M)A, and HEMA used to prepare the copolymer. The copolymers described in Table 3 were tested in foam formulations. Starting materials used in the foam formulations are described below in Table 4.

TABLE 4
Starting Materials for Foam Formulations

| Type | Name | Chemical Description | Source |
|---|---|---|---|
| Reactant | PAPI 580N | Diphenylmethane Diisocyanate, | Dow |
| | Polymeric MDI | isomers and homologues, Average | |
| | | Mw = 375, NCO content 30.8 wt % | |
| Reactant | Stepanpol 2352 | Aromatic Polyester Polyols, viscosity | Stepan Corp |
| | | @ 25° C. 3,000 cps, hydroxyl value: | |
| | | 240, average Mw = 468 | |
| Flame | TEP | Triethyl phosphate | Sigma |
| Retardant | | | |
| Additive | | | |
| Blowing | Deionized Water | Deionized Water, lab made | Dow |
| Agent | | | |
| Auxiliary | Cyclopentane | Cyclopentane (C-Pentane) | Sigma |
| Blowing | | | |
| Agent | | | |
| Auxiliary | Isopentane | Isopentane (i-pentane) | Sigma |
| Blowing | | | |
| Agent | | | |
| Catalyst | PMDETA | N,N,N′,N″,N″- | Huntsman |
| | | Pentamethyldiethylenetriamine | |
| Catalyst | Dabco K2097 | Potassium acetate in diethylene glycol | Evonik |
| | | (30 wt % Potassium acetate) | |
| Surfactant | VORASURF ™ DC | Dimethyl Siloxanes and Silicones, 3- | Dow |
| | 193 Additive | Hydroxypropyl Methyl, Ethoxylated | |
| | | Vis: 305 mPa*s, Calculated OH | |
| | | number 75 mg KOH/g | |
| Surfactant | Si-Acrylate Hybrid | Si-Acrylate Hybrids. | Dow, |
| | Inventive samples | X = 36 | Experimental |
| | 3- series, 4- series, | Y = 6 | materials |
| | 5- series, 6- series, | Or | prepared as |
| | PW-68 series | X = 24 | described in |
| | | Y = 2.4 | Synthesis |
| | | | Example 2 |

The Surfactants described in Table 3 above (prepared in Synthesis Example 2) have unit formula (Me₂SiO_{2/2})ₓ(MeR⁶SiO_{2/2})_{y}(Me₃SiO_{1/2})₂, where R⁶ has formula -D³-S—R⁷, where D³ is a propan-diyl group, and R⁷ is a monovalent polymeric group comprising units of formulae:

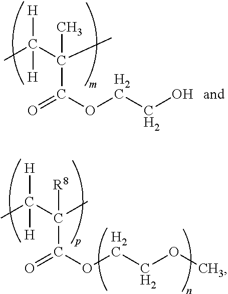

where subscript m is 0 to 10, subscript p is 1 to 5, and subscript n is 5 to 25, R⁸ is either H or Me (depending on whether PEGA-480 or PEGMA-300 was used), and R⁷ further comprises a terminal hydrogen atom or methyl group.

In this Example 3, foam formulations were prepared according to the following procedure:

### 1) Pre-Mixing Master Batch of Polyol Aka Pre-Blend.

Mix approximately 800-900 g of Stepanpol PS-2352 polyol, TEP, water, and catalyst blend (of PMDETA and Dabco K2097) together for 1 minute at 3000 RPM at the beginning of the experiment with a cowl blade in a 1 liter Nalgene bottle. This prepares a pre-blend.
   2) Mix the Cyclopentane and Iso-Pentane and Surfactant into the Pre-Blend to Make the B-Side (Note: A-Side is the MDI which Will be Mixed with B-Side in Step 3)
This was accomplished via air-driven mixer to avoid any ignition source with the pentane blend.
Cyclopentane and Iso-pentane were added with 2-3 g overage to account for evaporation during mixing.
Mixing was accomplished with a 2¾″ cowl-blade impellor and was done for 15 seconds at 3000 rpm to bring the B-side together.
Mixture was again weighed to adjust cyclopentane and iso-pentane level if necessary. Normal loading was as per formula ±2%. Remix if more was added.

### 3) Molded Foam Preparation

A wooden mold of height 10″×width 10″×depth 1.8″ was used, with an aluminum foil liner on each side to facilitate mold release and keep blowing agent in sample (similar to commercial PIR foam board stock).
   Mixing of the formulation parts was done in a 28 oz paper cold cup. The B-side (polyol blend, surfactant, and blowing agent prepared as described above) were first mixed to the proper ratios. PAPI 580N Polymeric MDI (MDI) was then weighed out to the necessary ISO index (290). The MDI was then poured into the B-side and vigorously mixed for 5 seconds with an air-driven mixer with a 2¾″ cowl mixing blade. This was then rapidly poured into the top of the mold and the foaming process proceeded.
   The prepared foam was then removed (after 15 minutes) and cut to size (8″×8″×1.8″) to be used for k-factor measurements. To minimize variation and blowing agent loss, the k-factor test was performed within 2 hours of making the foam.

TABLE 5
Two-Part Foam Formulations

| | | | | Control-1 | Control-2 | Control-3 | Inv-1, 2, 3, 4, 5, |
|---|---|---|---|---|---|---|---|
| | Type | Name | Units | (DC 193) | (1- series) | (2- series) | 6, 7, 8, 9, 10 |
| A | Reactant | PAPI | g | 154 | 154 | 154 | 154 |
| Side | | 580N | | | | | |
| | | Polymeric | | | | | |
| | | MDI | | | | | |
| B | Reactant | Stepanpol | g | 67.8 | 67.8 | 67.8 | 67.8 |
| Side | | 2352 | | | | | |
| (total | Flame | TEP | g | 12.5 | 12.5 | 12.5 | 12.5 |
| 100) | Retardant | | | | | | |
| | Additive | | | | | | |
| | Blowing | DI Water | g | 0.7 | 0.7 | 0.7 | 0.7 |
| | Agent | | | | | | |
| | Blowing | c-P/i-P | g | 14.2 | 14.2 | 14.2 | 14.2 |
| | Agent | (80/20) | | | | | |
| | Catalyst | PMDETA | g | 0.8 | 0.8 | 0.8 | 0.8 |
| | Catalyst | Dabco | | 1.5 | 1.5 | 1.5 | 1.5 |
| | | K2097 | | | | | |
| | Surfactant | Various | g | DC 193, 2.5 | (1--A, 1--B, | (2--A, 2--B, | (3--A, 3--B, |
| | | | | | 1--C, 1--D) | 2--C, 2--D) | 3--C, 3--D, |
| | | | | | 2.5 | 2.5 | 4--A, 5--A, |
| | | | | | | | 6--A, 6--B, |
| | | | | | | | 6--C, 6--D) |
| | | | | | | | 2.5 |

In this Example 4, the two-part foam formulations and foams made therefrom were evaluated, as follows:

### 1) Compatibility of Copolymers Prepared as Described Above in Pre-Blend

The Copolymer was mixed in the aforementioned pre-blend (of B-side), and the resulting mixture was visually observed for the clarity and miscibility of the mixture. If clear, it indicated good compatibility.

2) k-Factor Measurement

K-factor measurements of a foam sample were taken with a TA Instruments Lasercomp Fox 200 instrument. The temperatures used for measurement were top plate=0° C., bottom plate=25° C., with an average of 12.5° C.

### 3) Density Measurement

Density of a foam sample was mass divided by the volume of a center cut sample (1 inch×1 inch×2 inch)

### 4) Open Cell Content Measurement of a Foam Sample

By definition:

$$Closed cell content = ( pycnometric volume / geometric volume ) \times 100 \%$$

$$Open cell content = 100 \% - Closed cell content$$

A single run was performed on a 1″×1″×2″ sample to not over pressurize and rupture cells over many runs. The samples were prepared with a band saw out of the center of a foam in question, as far away from the mold edges as possible. The foam was placed in the pycnometer chamber, and the sample's mass and geometric dimensions were entered (which established the geometric volume). The gas pycnometer (Pentapyc 5200e by Quantachrome) ran a single pass at 5 psig and compared the volumes to calculate the closed and open cell content.

### 5) Smoke Density Measurement

Foam samples were prepared the day before they were to be burned (3 samples per foam). Cut foam samples slightly under 3×3×1″ were used. The testing was conducted in a smoke chamber with a photometric system following the procedure described in ASTM E-662 to operate the smoke chamber and data collection.

TABLE 6
Compatibility of Copolymers in B Side
of Two-Part Foam Formulations

| | | Compatibility in Pre-blend |
|---|---|---|
| | Samples | of B-side |
| Compar- | CE-1 (1--A), CE-2 (1--B), | Not miscible: mixtures display |
| ative | CE-3(1--C), CE-4 (1--D) and | visual evidence of aggregates |
| | CE-5 (2--A), CE-6 (2--B), | and have a hazy appearance |
| | CD-7 (2--C), CE-8 (2--D) | |
| Inv | Inv-1 (3--A), Inv-2 (3--B), | Miscible: the mixtures are |
| | Inv-3 (3--C), Inv-4 (3--D), | visually clear |
| | Inv-5 (4--A), Inv-6 (5--A), | |
| | Inv-7 (6--A), Inv-8 (6--B), | |
| | Inv-9 (6--C), Inv-10 (6--D) | |

TABLE 7
Insulation performance (k-factor) and open cell
rate of foams using various surfactants.

| Surfactants | Density (kg/m³) | k-factor | Open Cell % |
|---|---|---|---|
| Con-1 DC193 | 33.52 | 18.32 | 10.21 |
| Inv-1 (3--A) | 31.94 | 17.62 | 9.17 |
| Inv-2 (3--B) | 34.26 | 18.53 | 9.8 |
| Inv-3 (3--C) | 33.84 | 18.27 | 11.52 |
| Inv-4 (3--D) | 34.33 | 18.41 | 11.15 |
| Inv-5 (4--A) | 32.55 | 17.98 | 10.36 |
| Inv-6 (5--A) | 33.73 | 17.64 | 13.27 |
| Inv-7 (6--A) | 32.74 | 17.67 | 10.65 |
| Inv-8 (6--B) | 32.86 | 20.61 | 20.08 |
| Inv-9 (6--C) | 32.08 | 18.20 | 13.22 |
| Inv-10 (6--D) | 32.47 | 20.02 | 14.86 |

In this performance evaluation, the inventors found that samples containing a copolymer of this invention (Inv-1 to Inv-10) had good insulation performance compared to the sample containing the Control, DC 193. Among them, Inv-1, Inv-5, Inv-6 and Inv-7 showed very low (<18) k-factor (lower k-factor means better insulation performance). Without wishing to be bound by theory, it is thought that the results in Table 7 show that the Copolymer prepared as described herein can be used as a surfactant to develop new rigid foams with improved insulation performance and/or better energy saving than the control surfactant, under the conditions tested.

Smoke Density was tested as follows: Tested the max DS (max density of smoke) of part of inventive foam samples and control. The measured Max DS shows the three inventive samples have lower smoke density than the control which means better Fire Retardant performance.

TABLE 8
Smoke Density of foams using various surfactants

| Sample | Max DS |
|---|---|
| Con-1 (DC193) | 40 ± 3 |
| Inv-1 (3--A) | 26.5 ± 2.5 |
| Inv-4 (3--D) | 28.5 ± 5.5 |
| Inv-6 (5--A) | 22.7 ± 1.1 |

The data in Table 8 show that foams produced from formulations containing a Copolymer prepared as described herein have improved fire retardant performance than a foam prepared using the commercially available control surfactant, as evidenced by lower smoke density, Max DS, under the conditions tested.

### INDUSTRIAL APPLICABILITY

The Copolymer described herein has good compatibility and miscibility with the B-side of rigid foam formulations (i.e., the component of the foam formulation comprising a polyester polyol reactant, flame retardant additive, blowing agent, and catalyst). The Copolymer can be used in rigid foam formulations to provide foams with excellent insulation performance (low k-factor) and/or excellent fire retardance (low Smoke Density). Without wishing to be bound by theory, it is thought that when a silicone-(meth)acrylate-polyether copolymer contains ≥60 wt % silicone moieties, miscibility in the B-side of the rigid foam formulation may decrease. However, the inventors surprisingly found that when the Copolymer, prepared as described herein, comprises 40 wt % to <60 wt %, alternatively 42 wt % to 58 wt % of silicone moieties and 30 wt % to 40 wt % (meth)acrylate-poly(alkylene glycol) moieties (and optionally 0 to 10 wt % of a (meth)acrylate monomer moiety), the Copolymer has both good compatibility in the B-side of the rigid foam formulation and provides good insulation performance and/or fire retardance to the foam made from the formulation.

Furthermore, the method for manufacturing the Copolymer described herein may minimize or avoid the generation of aldehyde by-products, such as formaldehyde, resulting in improved foam formulations over foam formulations containing SPEs with formaldehyde impurities.

### Definitions and Usage of Terms

All amounts, ratios, and percentages herein are by weight, unless otherwise indicated. The articles ‘a’, ‘an’, and ‘the’ each refer to one or more, unless otherwise indicated by the context of specification. The singular includes the plural unless otherwise indicated. The SUMMARY and ABSTRACT are hereby incorporated by reference. The transitional phrases “comprising”, “consisting essentially of”, and “consisting of” are used as described in the Manual of Patent Examining Procedure Ninth Edition, Revision 08.2017, Last Revised January 2018 at section § 2111.03 I., II., and III. Any feature or aspect of the invention may be used in combination with any other feature or aspect recited herein. The abbreviations used herein have the definitions in Table 9.

TABLE 9
Abbreviations

| Abbreviation | Definition |
|---|---|
| @ | at |
| AIBN | 2,2′-Azobis(2-methylpropionitrile) purchased from |
| | Sigma-Aldrich, Inc. |
| ° C. | degrees Celsius |
| Da | Dalton |
| DI | deionized |
| EtOAc | Ethyl acetate |
| g | gram |
| HEMA | Hydroxyethyl methacrylate |
| hrs or hr | hours |
| L | liter |
| m | meter |
| (meth)acryl | methacryl and/or acryl functionality |
| or M(A) | |
| mins | minutes |
| mL or ml | milliliter |
| Mn | number average molecular weight |
| PDMS | polydimethylsiloxane |
| PEG | poly(ethylene glycol) |
| psig | pounds per square inch, gauge |
| RPM | revolutions per minute |
| RT | Room temperature of 23 ± 3° C. |
| SPE | Silicone polyether |
| μm | micrometer |

1. A silicone-(meth)acrylate-polyether copolymer comprising unit formula: (R¹₂SiO_{2/2})ₓ(R¹R²SiO_{2/2})_{y}(R¹₃SiO_{1/2})_{z}, where
subscripts x, y, and z each represent average numbers of each unit in the unit formula, and subscripts x, y, and z have average values such that
z=2,
x=10 to 40, and
y=1 to 10,
each R¹ is an independently selected alkyl group of 1 to 10 carbon atoms;
each R² is an independently selected group of formula:
-D¹-S—R¹⁰, where each D¹ is an independently selected alkane-diyl group of 1 to 16 carbon atoms, and
R¹⁰ has formula 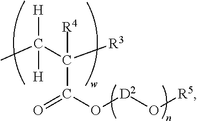
where
each R³ is an endblocker for a poly(meth)acrylate chain,
each R⁴ is independently selected from H or methyl,
each D² is independently selected alkane-diyl group of 2 to 4 carbon atoms,
each subscript n is independently 1 to 25,
each R⁵ is independently selected from H and an alkyl group of 1 to 4 carbon atoms,
each subscript w is independently >0 to 20, and
with the provisos that in at least one instance of R¹⁰, per molecule, subscript n is 5 to 20.

2. The copolymer of claim 1, wherein the copolymer has a random distribution of pendant groups, R².

3. The copolymer of claim 1, where R¹ is methyl, D¹ has empirical formula —C₃H₆—, R⁵ is hydrogen or methyl, D² has empirical formula —C₂H₄—, and in at least one instance of R¹⁰, per molecule, subscript n is 6 to 20.

4. A method of making the copolymer of claim 1, wherein the method comprises:
1) combining, under conditions to effect free radical polymerization reaction, starting materials comprising
A) a mercapto-functional polydiorganosiloxane comprising unit formula: (R¹₂SiO_{2/2})ₓ(R¹R⁹SiO_{2/2})_{y}(R¹₃SiO_{1/2})_{z}, where
subscripts x, y, and z each represent average numbers of each unit in the unit formula, and subscripts x, y, and z have average values such that
z=2,
x=10 to 40, and
y=1 to 10,
each R¹ is an independently selected alkyl group of 1 to 10 carbon atoms; and
each R⁹ is an independently selected mercaptoalkyl group of formula -D¹-SH,
where each D¹ is an independently selected alkane-diyl group of 2 to 10 carbon atoms;
B) a (meth)acrylate-poly(alkylene glycol) of formula 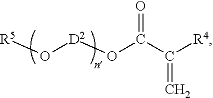
where
each R⁵ is independently selected from H and an alkyl group of 1 to 4 carbon atoms,
each D² is independently selected alkane-diyl group of 2 to 4 carbon atoms,
each R⁴ is independently selected from H or methyl, and
subscript n′ is 5 to 20;
optionally C) a (meth)acrylate monomer of formula 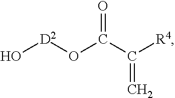
where
each D² is independently selected alkane-diyl group of 2 to 4 carbon atoms, and
each R⁴ is independently selected from H or methyl;
D) a free radical initiator; and
optionally E) a solvent
thereby producing a reaction product comprising the copolymer; and
optionally 2) purifying the reaction product, thereby recovering the copolymer.

5. The method of claim 4, where A) the mercapto-functional polydiorganosiloxane has a random distribution of mercapto-functional groups, R⁹.

6. The method of claim 4, where each R¹ is methyl, each D¹ has empirical formula —C₃H₆—, each R⁵ is hydrogen or methyl, each D² has empirical formula —C₂H₄—, and subscript n′ is 6 to 20.

7. The method of claim 4, where B) the (meth)acrylate-poly(alkylene glycol) comprises poly(ethylene glycol) methyl ether (meth)acrylate with average Mn of 300 to 480 g/mole.

8. The method of claim 4, where C) the (meth)acrylate monomer is present.

9. The method of claim 8, where C) the (meth)acrylate monomer comprises hydroxyethyl methacrylate.

10. The method of claim 4, where D) the free radical initiator comprises 2,2′-Azobis(2-methylpropionitrile).

11. The method of claim 4, where E) the solvent is present and comprises ethyl acetate.

12.-13. (canceled)

14. A two part foam formulation comprising:
I) a first part comprising
i) an isocyanate component, and
II) a second part comprising
ii) a polyol,
iii) a blowing agent, and
iv) a surfactant, wherein the surfactant comprises a silicone-(meth)acrylate-polyether copolymer comprising unit formula: (R¹₂SiO_{2/2})ₓ(R¹R²SiO_{2/2})_{y}(R¹₃SiO_{1/2})_{z}, where
subscripts x, y, and z each represent average numbers of each unit in the unit formula, and subscripts x, y, and z have average values such that
z=2,
x=10 to 40, and
y=1 to 10,
each R¹ is an independently selected alkyl group of 1 to 10 carbon atoms;
each R² is an independently selected group of formula:
-D¹-S—R¹⁰, where each D¹ is an independently selected alkane-diyl group of 1 to 16 carbon atoms, and
R¹⁰ has formula 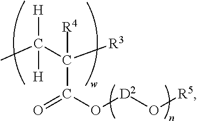
where
each R³ is an endblocker for a poly(meth)acrylate chain,
each R⁴ is independently selected from H or methyl,
ach D² is independently selected alkane-diyl group of 2 to 4 carbon atoms,
each subscript n is independently 1 to 25,
each R⁵ is independently selected from H and an alkyl group of 1 to 4 carbon atoms,
each subscript w is independently>0 to 20, and
with the provisos that in at least one instance of R¹⁰, per molecule, subscript n is 5 to 25; and
optionally an additive selected from the group consisting of a flame retardant, a catalyst, and a co-surfactant having a chemical structure different from the copolymer.

15. A method for preparing a foam comprising:
1) providing the two part foam formulation of claim 14, and
2) combining the first part and the second part of the two part foam formulation.

16. The two part foam formulation of claim 14, wherein the silicone-(meth)acrylate-polyether copolymer has a random distribution of pendant groups, R².

17. The two part foam formulation of claim 14 or claim 16, wherein the silicone-(meth)acrylate-polyether copolymer has R¹ is methyl, D¹ has empirical formula —C₃H₆—, R⁵ is hydrogen or methyl, D² has empirical formula —C₂H₄—, and in at least one instance of R¹⁰, per molecule, subscript n is 6 to 20.

18. The method of claim 4, wherein B) the (meth)acrylate-poly(alkylene glycol) of formula 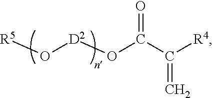
has each R⁵ is methyl, each D² has 2 carbon atoms, each R⁴ is H, and subscript n′ is 9.

19. The method of claim 4, wherein B) the (meth)acrylate-poly(alkylene glycol) of formula 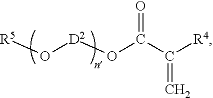
has each R⁵ is methyl, each D² has 2 carbon atoms, each R⁴ is methyl, and subscript n′ is 5.
